(19) United States
(12) Patent Application Publication
(10) Pub. No.: US 2026/0119849 A1
(43) Pub. Date: Apr. 30, 2026

(54) INVERSION METHOD AND SYSTEM OF DIRECT-CURRENT RESISTIVITY BASED ON UNSUPERVISED DEEP LEARNING

(71) Applicant: SHANDONG UNIVERSITY, Jinan, Shandong (CN)

(72) Inventors: Bin LIU, Jinan (CN); Peng JIANG, Jinan (CN); Yonghao PANG, Jinan (CN); Zhengyu LIU, Jinan (CN); Benchao LIU, Jinan (CN)

(73) Assignee: SHANDONG UNIVERSITY, Jinan, Shandong (CN)

(21) Appl. No.: 19/141,816

(22) PCT Filed: Oct. 31, 2023
(86) PCT No.: PCT/CN2023/128712

§ 371 Date: Jun. 20, 2025

(30) Foreign Application Priority Data
Dec. 20, 2022 (CN) 202211640685.7

(51) Int. Cl. G06N 3/0475; G06N 3/088; G06N 3/096

(52) U.S. Cl. CPC G06N 3/0475; G06N 3/088; G06N 3/096

(57) ABSTRACT

An inversion method of direct-current (DC) resistivity based on unsupervised deep learning (DL), includes: constructing an unsupervised DC resistivity inversion network architecture, and adding a dynamic smoothing regularization term to a loss function; constructing a simulated sample database with reference to geologic conditions of an explored region, and constructing an actual sample database by using data generated in an early stage of engineering by means of a domain transfer method; and pre-training an unsupervised neural network by using the simulated sample database, then performing secondary training on the network by using the actual sample database by means of a linear probing and full fine tuning-based transfer learning method, finally, substituting newly collected observation data into the trained network, performing, based on a network constraint, iterative inversion on a single actual sample multiple times, and obtaining a predicted resistivity model.

The present invention claims priority to Chinese Patent Application No. 202211640685.7, filed to the China National Intellectual Property Administration on Dec. 20, 2022 and entitled “INVERSION METHOD AND SYSTEM OF DIRECT-CURRENT RESISTIVITY BASED ON UNSUPERVISED DEEP LEARNING”, the entire content of which is incorporated herein by reference.

### TECHNICAL FIELD

The present invention belongs to the technical field of geophysical exploration, and relates to an inversion method and system of direct-current (DC) resistivity based on unsupervised deep learning (DL).

### BACKGROUND

The description in this section merely provides background information related to the present invention and does not necessarily constitute the prior art.

A DC resistivity detection method, which is sensitive to subsurface water content, is an effective method for detecting a water-containing structure. Because of an acquisition method with low economic costs, high exploration efficiency, and flexible construction, the method can satisfy various detection environment and engineering requirements, such as potential threat detection in hydraulic and hydroelectric engineering, and geological survey for road and railway traffic engineering, thereby having important value in engineering. Observation data may be reconstructed into a resistivity model by an inversion method, thereby resolving the geological problem. Because the inverse problem has the defect of multiple solutions, selecting an effective inversion method is a key to ensure a detection effect of the DC resistivity.

Currently, a linear inversion method is a mainstream method in actual applications. However, an inversion result thereof depends on an initial model, and is prone to being trapped in local optimization, consequently leading to incorrect geological interpretation. By solving the inverse problem by means of DL, the defect of local optimization can be overcome, which has become a research hotspot in recent years. In the existing DL-based DC resistivity inversion, a network is trained in a supervised manner, and a large quantity of real resistivity models need to be used as labels for training set. However, it is usually difficult to obtain the real resistivity model during actual detection, and the network cannot be effectively trained due to the lack of labels. Consequently, the existing method has a relatively poor effect in actual data. An unsupervised inversion method can train the network through dual driving of a physical law and data mining without dependency on the real model, and thus has feasibility of being applied to the actual data. Currently, no inversion method of DC resistivity based on unsupervised DL has been implemented.

There are the following three problems in implementing the inversion method of DC resistivity based on unsupervised DL.

First, currently, there is no existing unsupervised DC resistivity inversion network. In view of this, the physical law of an electric field needs to be integrated into existing network architecture, and then only observation data is needed for training a network. In this way, dependency of network training on the label is eliminated from the essence of the method.

Second, due to multiple solutions of the inverse problem, gradient computation is prone to be incorrect, leading to a poor network training effect. Based on network training driven by the physical law, a constraint needs to be imposed on a network training process to relieve the problem of multiple solutions, thereby improving an inversion imaging effect.

Third, costs of obtaining the actual data are high, and it is difficult to satisfy a volume required for network training. Consequently, the unsupervised DC resistivity inversion method has a poor effect in actual detection. Transfer learning is a good way to solve the problem, but a robust DC resistivity transfer learning method is lacking at present.

### SUMMARY

To solve the above problems, the present invention provides an inversion method and system of DC resistivity based on unsupervised DL. The present invention enables unsupervised DL inversion of actually collected DC resistivity observation data to obtain a resistivity model, and uses a regularization constraint to improve an imaging effect.

According to some embodiments, the present invention uses technical solutions as follows.

An inversion method of DC resistivity based on unsupervised DL, comprising:
adding a forward modeling process to a neural network architecture to construct an unsupervised DC resistivity inversion network;
adding a dynamic smoothing regularization term to a loss function used for driving update of network parameters;
designing geoelectric models based on the geological conditions of the survey area, and generating a synthetic dataset containing a sufficiently large volume of simulated observation data;
pre-training the unsupervised DC resistivity inversion network by using the sample database to preliminarily determine a mapping function between observation data and a resistivity model;
performing secondary training on the network by using actually collected data by means of linear probing and full fine tuning-based transfer learning to optimize the mapping function between the observation data and the resistivity model;
substituting newly collected observation data into the trained network, performing, based on a network constraint, iterative inversion on a single actual sample multiple times, and finally outputting and obtaining a predicted resistivity model; and
performing DC resistivity inversion by using the final predicted resistivity model.

As an optional implementation mode, a specific process of adding a forward modeling process to a neural network architecture to construct an unsupervised DC resistivity inversion network comprises: implementing, using a finite element/finite difference method, a point-source forward modeling process as a forward modeling module, splicing the forward modeling module to an output end of a neural network, performing forward modeling on the predicted model to obtain predicted data, and updating the network parameters by fitting the predicted data and input data to implement network training.

As an optional implementation mode, a specific process of adding the dynamic smoothing regularization term to the loss function used for driving update of the network parameters comprises:
adding the dynamic smoothing regularization term to the loss function, where a calculation formula is:

$$Loss = {( G ( m ) - {d}^{obs} )}^{T} ( G ( m ) - {d}^{obs} ) + {λ ( Cm )}^{T} ( Cm )$$

where, G(·) is the forward modeling process, m represents a resistivity model, d^{obs} is observation data inputted to the network, C is a smooth constraint matrix, and is used for approximating a first-order/second-order derivative of m in space, and λ is a regularization parameter.

As an optional implementation mode, the constructing a sample database comprises constructing a simulated sample database, determining modeling parameters according to an actually detected electrode arrangement manner, an electrode spacing, and a detection requirement, and performing numerical forward modeling using the finite element or finite difference method to generate a sufficient number of observation samples corresponding to the geoelectric models, thereby forming the synthetic training dataset.

As an optional implementation mode, the constructing a sample database comprises constructing an actual sample database, and processing actual data collected in a similar detection scenario by using a data domain transfer method to make the actual data have similar features as simulated data, so as to obtain the actual sample database.

As an optional implementation mode, a specific process of performing secondary training on the network by means of linear probing and full fine tuning-based transfer learning comprises:
after pre-training the network by using the simulated sample database, performing secondary training on the network by using the actual sample database;
the secondary training being training a last network layer parameter again by using linear probing, and training all network layer parameters by using full fine tuning.

As an optional implementation mode, a specific process of performing, based on a network constraint, iterative inversion on a single actual sample multiple times comprises: after the observation data is inputted into the inversion network, obtaining a first predicted resistivity model through mapping, using the forward modeling module to obtain corresponding data, and then calculating a residual between the corresponding data and the inputted observation data; outputting the resistivity model as a final model if the residual is less than a set value, and calculating the loss function to update the network parameters if the residual is greater than the set value, so as to regenerate a model; and repeating the above process until the residual converges.

An inversion system of DC resistivity based on unsupervised DL, comprising:
a forward modeling network module, configured to add a forward modeling process to a neural network architecture to construct an unsupervised DC resistivity inversion network;
a constraint module, configured to add a dynamic smoothing regularization term to a loss function used for driving update of network parameters;
a sample database construction module, configured to design geoelectric models with reference to geological conditions of an explored region, and then construct a sample database comprising simulated observation data exceeding a set amount;
an initial training module, configured to pre-train the unsupervised DC resistivity inversion network by using the sample database to preliminarily determine a mapping function between observation data and a resistivity model;
a secondary training module, configured to perform secondary training on the network by using actually collected data by means of linear probing and full fine tuning-based transfer learning to optimize the mapping function between the observation data and the resistivity model;
a final optimization module, configured to substitute newly collected observation data into the trained network, performing, based on a network constraint, iterative inversion on a single actual sample multiple times, and finally outputting and obtaining a predicted resistivity model; and
an inversion module, configured to perform DC resistivity inversion by using the final predicted resistivity model.

A computer-readable storage medium, storing a plurality of instructions thereon; wherein the instructions are applicable to be loaded by a processor of a terminal device, to cause the processor to execute the steps in the method.

A terminal device, comprising a processor and a computer-readable storage medium, where the processor is configured to implement each instruction; and the computer-readable storage medium is configured to store a plurality of instructions, and the instructions are applicable to be loaded by the processor and execute steps in the method.

Compared with the prior art, the present invention has the beneficial effects as follows.

In the present invention, to solve the problems that an existing DL inversion method of resistivity cannot be easily applied to actual data due to the facts that its training is dependent on a label and the physical essence of electric field propagation is not considered, electric field forward modeling representing a physical law is added to an inversion network architecture to replace the function of the label, an unsupervised DC resistivity inversion network architecture is constructed, which improves generalization of the inversion network, thereby laying a theoretical basis for DC resistivity inversion and detection in an engineering site.

In the present invention, to solve the problems of complicated multiple solutions of the inverse problem of resistivity and difficult accurate imaging of the inversion network, the dynamic smooth constraint used for relieving the problem of multiple solutions is added to the loss function, thereby improving stability of network training and ensuring an inversion imaging effect of the network.

In the present invention, to solve the problem that it is difficult for actual data to satisfy the sample size required for network training, a transfer learning method applicable to actual data of an electrical method is established, thereby reducing the requirement of the network for an actual sample size, and effectively inversing the actual data by multiple iterations based on the network constraint.

### BRIEF DESCRIPTION OF THE DRAWINGS

The accompanying drawings constituting a part of the present invention are used to provide a further understanding of the present invention. The exemplary examples of the present invention and descriptions thereof are used to explain the present invention, and do not constitute an improper limitation to the present invention.

FIG. 1 shows a flowchart of an inversion method of DC resistivity based on unsupervised DL according to an example of the present invention;

FIG. 2 shows a schematic diagram of geoelectric models in a simulated sample database constructed in an example; and

FIG. 3 shows an inversion result of unsupervised DL in an example.

### DETAILED DESCRIPTION

The present invention is further described below with reference to the accompanying drawings and embodiments.

It should be pointed out that the following detailed descriptions are all illustrative and are intended to provide further descriptions of the present invention. Unless otherwise specified, all technical and scientific terms used herein have the same meanings as those usually understood by a person of ordinary skill in the art to which the present invention belongs.

It should be noted that the terms used herein are merely used for describing specific implementations, and are not intended to limit exemplary implementations of the present invention. As used herein, the singular form is intended to comprise the plural form, unless the context clearly indicates otherwise. In addition, it should further be understood that terms “comprise” and/or “comprising” used in this specification indicate that there are features, steps, operations, devices, components, and/or combinations thereof.

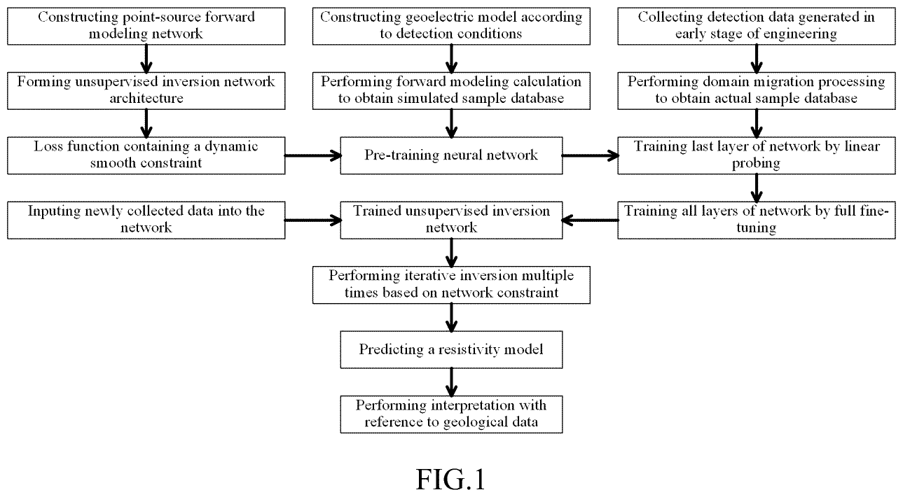

The present example discloses an inversion method of DC resistivity based on unsupervised DL. As shown in FIG. 1, the method comprises the following steps:

Step S1: A large quantity of geoelectric models are constructed according to a detection scenario, corresponding observation data is calculated by means of numerical simulation of forward modeling, and then a simulated data sample database is constructed.

In some examples, geoelectric models are designed with reference to geological conditions of an explored region, and then a sample database comprising a large amount of simulated observation data is constructed.

Modeling parameters are determined according to an actually detected electrode arrangement manner, electrode spacing, a detection requirement, and the like. An observation apparatus is usually a Wenner-Schlumberger, monopole-dipole, and dipole-dipole apparatus. Numerical simulation of forward modeling is performed by using a finite element/finite difference method, and a large amount of observation data corresponding to the geoelectric models is obtained as the sample database.

An identification method in the present example is mainly for bad geologic bodies such as faults and caverns in underground engineering, which are represented by the geoelectric models incorporating anomalous bodies with different resistivities, positions, and morphological characteristics.

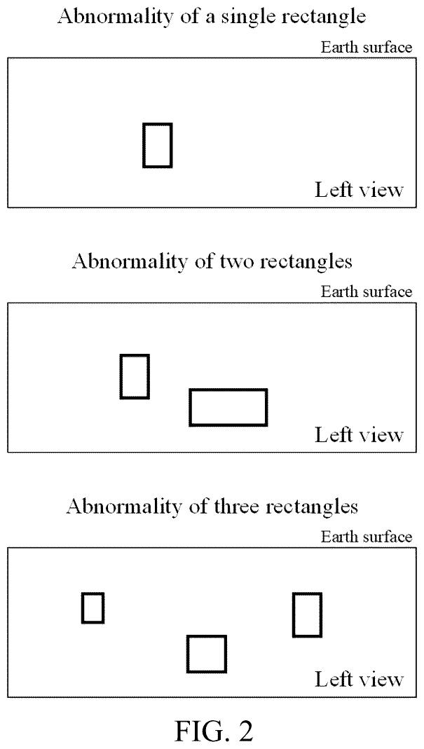

As shown in FIG. 2, based on the detection environment of Yunnan Dehou Reservoir, a model in the present example is set with dimensions of 5 m(X)×186 m(Y)×32 m(Z). There are three survey lines spanning 186 m in length, with a survey line spacing of 1 m. There are 63 electrode points, with an electrode spacing of 3 m. The background resistivity is in a range of 400-500 Ω·m, while there are 1-3 blocky low-resistivity anomalous bodies, and a resistivity value is in a range of 10-20 Ω·m. The observation apparatus is a Wenner-Schlumberger and dipole-dipole apparatus.

Step S2: A small amount of actual data generated in an early stage of engineering is used as a sample database for secondary training, and is processed by using a domain transfer method.

Step S3: A forward modeling module is added to neural network architecture to construct unsupervised DC resistivity inversion network architecture.

A dynamic smoothing regularization term is added to a loss function to enhance stability of network training.

In the present example, by using the finite element/finite difference method, a point-source forward modeling process is implemented as the forward modeling module, the forward modeling module is spliced to an output end of a neural network, forward modeling is performed on a predicted model to obtain predicted data, and network parameters are updated by fitting the predicted data and input data to implement network training.

A specific process of adding the dynamic smoothing regularization term to the loss function comprises:
the loss function based on the dynamic smooth constraint is as follows:

$$Loss = {( G ( m ) - {d}^{obs} )}^{T} ( G ( m ) - {d}^{obs} ) + {λ ( Cm )}^{T} ( Cm )$$

where, G(·) is the forward modeling process, m represents a resistivity model, d^{obs} is observation data inputted to the network, C is a smooth constraint matrix, and is used for approximating a first-order/second-order derivative of m in space, and λ is a regularization parameter. A model gradient δm may be obtained by using the Gaussian-Newton method, and then all the network parameters are updated.

$$δ m = {( {J}^{T} J + λ {C}^{T} C )}^{- 1} {J}^{T} δ {d}^{obs}$$

A dynamic regularization parameter A is calculated as follows:

$$λ = {λ}_{0} \times {( 1.0 - epoch / max\_epoch )}^{μ}$$

where, λ₀ is an initial value of the regularization parameter, and max_epoch is a maximum value of training times set for the network. μ is a change rate factor.

Step S4: As shown in FIG. 1, the unsupervised DC resistivity inversion network is trained by using the simulated sample database and an actual data sample database in sequence.

Secondary training is performed on the network by using actually collected data by means of linear probing and full fine tuning-based transfer learning to optimize a mapping function between the observation data and the resistivity model.

A specific process of performing secondary training on the network by means of a transfer learning method comprises the following steps:
First, the actual data is processed by using a data domain transfer method, so that the actual data has similar features as simulated data. When a data amount is relatively small, linear fitting may be performed, and when the data amount is relatively large, an existing technology such as an adversarial neural network may be used for implementation.
Second, linear probing is performed on the pre-trained network by using the processed actual data, and a last linear layer is trained again.

Finally, the network is full fine-tuned, and network parameters of all layers are updated at the same time.

Main network parameters and hardware conditions in the present example are: the network is established based on a PyTorch platform, one NVIDIA TITAN RTX graphics card with a 24G video memory is used for calculation, and the card comprises 4608 stream processing units. The main network parameters are: an SGD optimizer is used, the Batchsize is set to 12, and herein, the Batchsize is equal to 8. The learning rate is 0.01 to 0.02, the momentum is 0.9, the weight decay is 1e-4, and the maximum value of training times, epoch, set for the network is 100.

Step S5: Newly collected observation data is substituted into the trained network, based on a network constraint, iterative inversion is performed on a single actual sample multiple times, and finally a predicted resistivity model is output.

After the observation data of the single sample is inputted into the inversion network, a first predicted resistivity model is obtained through mapping, the forward modeling module is used to obtain corresponding data, and then a residual between the corresponding data and the inputted observation data is calculated. The resistivity model is outputted as a final model if the residual is relatively small, and the loss function is calculated to update the network parameters if the residual is relatively large, so as to regenerate a model. The process is repeated until the residual converges.

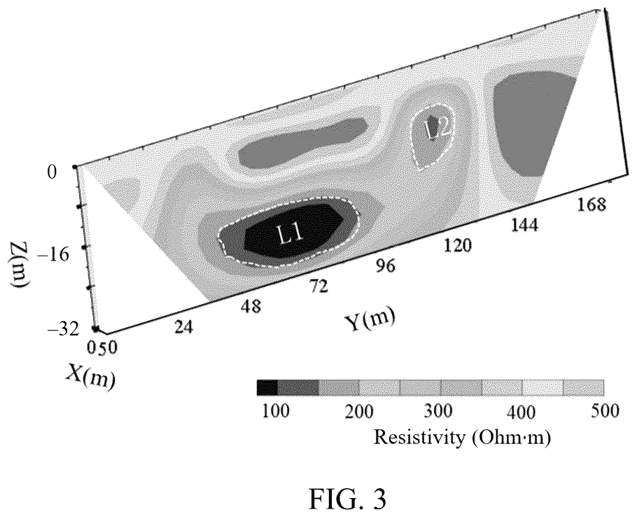

The trained unsupervised DL network constructs the mapping function between the observation data and the resistivity model, an inversion process may be replaced, actual data newly collected in Dehou Reservoir is substituted, and an imaging result is as shown in FIGS. 3. A 50-85 m region (L1) and a 110-125 m region (L2) in a horizontal direction are obvious low-resistivity regions. With reference to the geological data, it is predicted that the regions may be aquifer regions in a karst zone or shallow quaternary soil. The detection result is verified by borehole coring, and a detection effect may reach a requirement of an engineering application.

A person skilled in the art should understand that the embodiments of the present invention may be provided as a method, a system, or a computer program product. Therefore, the present invention may use a form of hardware-only embodiments, software-only embodiments, or embodiments with a combination of software and hardware. Moreover, the present invention may use a form of a computer program product that is implemented on one or more computer-usable storage media (comprising, but not limited to, a disk memory, a compact disc read-only memory (CD-ROM), an optical memory, and the like) that comprise computer-usable program code.

The present invention is described with reference to the flowcharts and/or block diagrams of the method, the device (system), and the computer program product according to the embodiments of the present invention. It should be understood that computer program instructions can implement each procedure and/or block in the flowcharts and/or block diagrams and a combination of procedures and/or blocks in the flowcharts and/or block diagrams. These computer program instructions may be provided to a general-purpose computer, a special-purpose computer, an embedded processor, or a processor of another programmable data processing device to generate a machine, so that an apparatus configured to implement functions specified in one or more procedures in the flowcharts and/or one or more blocks in the block diagrams is generated by using instructions executed by the computer or the processor of another programmable data processing device.

These computer program instructions may alternatively be stored in a computer-readable memory that can instruct a computer or another programmable data processing device to work in a specific manner, so that the instructions stored in the computer-readable memory generate an artifact that comprises an instruction apparatus. The instruction apparatus implements functions specified in one or more procedures in the flowcharts and/or in one or more blocks in the block diagrams.

These computer program instructions may further be loaded onto a computer or another programmable data processing device, so that a series of operation steps are performed on the computer or the another programmable device, thereby generating computer-implemented processing. Therefore, the instructions executed on the computer or the another programmable device provide steps for implementing functions specified in one or more procedures in the flowcharts and/or in one or more blocks in the block diagrams.

The foregoing descriptions are merely preferred embodiments of the present invention, but are not intended to limit the present invention. A person skilled in the art may make various alterations and variations to the present invention. Any modification, equivalent replacement, or improvement made and the like within the spirit and principle of the present invention shall fall within the protection scope of the present invention.

The specific implementations of the present invention are described above with reference to the accompanying drawings, but are not intended to limit the protection scope of the present invention. A person skilled in the art should understand that various modifications or deformations may be made without creative efforts based on the technical solutions of the present invention, and such modifications or deformations shall fall within the protection scope of the present invention.

1. An inversion method of direct-current (DC) resistivity based on unsupervised deep learning (DL), comprising:
adding a forward modeling process to a neural network architecture to construct an unsupervised DC resistivity inversion network;
adding a dynamic smoothing regularization term to a loss function used for driving update of network parameters;
designing geoelectric models based on the geological conditions of the survey area, and generating a synthetic dataset containing a sufficiently large volume of simulated observation data;
pre-training the unsupervised DC resistivity inversion network by using the sample database to establish an initial mapping between observation data and a resistivity model;
performing secondary training on the network by using actually collected data by means of linear probing and full fine tuning-based transfer learning to optimize the mapping function between the observation data and the resistivity model;
feeding new field data into the trained network, performing, based on a network constraint, iterative inversion on a single actual sample multiple times, and finally outputting and obtaining a predicted resistivity model; and
performing DC resistivity inversion by using the final predicted resistivity model.

2. The inversion method of DC resistivity based on unsupervised DL according to claim 1, wherein a specific process of adding a forward modeling process to a neural network architecture to construct an unsupervised DC resistivity inversion network comprises: implementing, using a finite element/finite difference method, a point-source forward modeling process as a forward modeling module, splicing the forward modeling module to an output end of a neural network, performing forward modeling on the predicted model to obtain predicted data, and updating the network parameters by fitting the predicted data and input data to implement network training.

3. The inversion method of DC resistivity based on unsupervised DL according to claim 1, wherein a specific process of adding the dynamic smoothing regularization term to the loss function used for driving update of the network parameters comprises:
adding the dynamic smoothing regularization term to the loss function, wherein a calculation formula is:
$$Loss = {( G ( m ) - {d}^{obs} )}^{T} ( G ( m ) - {d}^{obs} ) + {λ ( Cm )}^{T} ( Cm )$$
wherein, G(·) is the forward modeling process, m represents a resistivity model, d^{obs} is observation data inputted to the network, C is a smooth constraint matrix, and is used for approximating a first-order/second-order derivative of m in space, and λ is a regularization parameter.

4. The inversion method of DC resistivity based on unsupervised DL according to claim 1, wherein the constructing a sample database comprises constructing a simulated sample database, determining modeling parameters according to an actually detected electrode arrangement manner, an electrode spacing, and a detection requirement, and performing numerical forward modeling using the finite element or finite difference method to generate a sufficient number of observation samples corresponding to the geoelectric models, thereby forming the synthetic training dataset.

5. The inversion method of DC resistivity based on unsupervised DL according to claim 1, wherein the constructing a sample database comprises constructing an actual sample database, and processing actual data collected in a similar detection scenario by using a data domain transfer method to make the actual data have similar features as simulated data, so as to obtain the actual sample database.

6. The inversion method of DC resistivity based on unsupervised DL according to claim 1, wherein a specific process of performing secondary training on the network by means of linear probing and full fine tuning-based transfer learning comprises:
after pre-training the network by using the simulated sample database, performing secondary training on the network by using the actual sample database;
the secondary training being training a last network layer parameter again by using linear probing, and training all network layer parameters by using full fine tuning.

7. The inversion method of DC resistivity based on unsupervised DL according to claim 1, wherein a specific process of performing, based on a network constraint, iterative inversion on a single actual sample multiple times comprises: after the observation data is inputted into the inversion network, obtaining a first predicted resistivity model through mapping, using the forward modeling module to obtain corresponding data, and then calculating a residual between the corresponding data and the inputted observation data; outputting the resistivity model as a final model if the residual is less than a set value, and calculating the loss function to update the network parameters if the residual is greater than the set value, so as to regenerate a model; and repeating the above process until the residual converges.

8. An inversion system of direct-current (DC) resistivity based on unsupervised deep learning (DL), comprising:
a forward modeling network module, configured to add a forward modeling process to a neural network architecture to construct an unsupervised DC resistivity inversion network;
a constraint module, configured to add a dynamic smoothing regularization term to a loss function used for driving update of network parameters;
a sample database construction module, configured to design a geoelectric model with reference to geological conditions of an explored region, and then construct a training dataset that contains a sufficient volume of simulated observation data;
an initial training module, configured to pre-train the unsupervised DC resistivity inversion network by using the sample database to preliminarily determine a mapping function between observation data and a resistivity model;
a secondary training module, configured to perform secondary training on the network by using actually collected data by means of linear probing and full fine tuning-based transfer learning to optimize the mapping function between the observation data and the resistivity model;
a final optimization module, configured to substitute newly collected observation data into the trained network, performing, based on a network constraint, iterative inversion on a single actual sample multiple times, and finally outputting and obtaining a predicted resistivity model; and
an inversion module, configured to perform DC resistivity inversion by using the final predicted resistivity model.

9. A computer-readable storage medium, storing a plurality of instructions, wherein the instructions are applicable to be loaded by a processor of a terminal device and execute steps in the method according to claim 1.

10. A terminal device, comprising a processor and a computer-readable storage medium, wherein the processor is configured to implement each instruction; and the computer-readable storage medium is configured to store a plurality of instructions, and the instructions are applicable to be loaded by the processor and execute steps in the method according to claim 1.
